(19) United States
(12) Patent Application Publication
(10) Pub. No.: US 2009/0208798 A1
(43) Pub. Date: Aug. 20, 2009

(54) Humidification system using injector for fuel cell stack

(75) Inventors: Hyun Yoo Kim, Gyeonggi-do (KR); Yong Sun Park, Gyeonggi-do (KR); Hyuck Roul Kwon, Gyeonggi-do (KR); Min Soo Kim, Seoul (KR); Beom Jun Kim, Gwangju (KR); Seok Lae Kim, Seoul (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR)

(21) Appl. No.: 12/218,947

(22) Filed: Jul. 17, 2008

(30) Foreign Application Priority Data
Feb. 15, 2008 (KR) 10-2008-0013727

(51) Int. Cl. H01M 8/04

(52) U.S. Cl. 429/26; 429/34

(57) ABSTRACT

A humidification system using an injector for a fuel cell stack includes: a fuel cell separator including a reaction flow field, and an air inlet port and an air outlet port formed at a front portion and an end portion of the reaction flow field, respectively; a humidification chamber provided at a part of or the whole length of the front portion of the reaction flow field of the separator; and an injector mounted at a starting point of the humidification chamber to inject a mixture of water and air into the humidification chamber. With the system, humidification efficiency can be improved and/or maximized without an increase in the volume of the fuel cell stack.

### CROSS-REFERENCE TO RELATED APPLICATION

This application claims under 35 U.S.C. §119(a) the benefit of Korean Patent Application No. 10-2008-0013727 filed Feb. 15, 2008, the entire contents of which are incorporated herein by reference.

### BACKGROUND

(a) Technical Field

The present invention relates to a humidification system using an injector for a fuel cell stack. More particularly, the present invention relates to a humidification system using an injector for a fuel cell stack, in which an injector and a humidification chamber are provided on an inlet side of a separator as means for humidifying a fuel cell stack of a fuel cell vehicle so as to inject a mixture of water and air to the humidification chamber, thus maximizing humidification efficiency without an increase in the volume of the fuel cell stack.

(b) Background Art

A fuel cell vehicle is driven by a fuel cell that converts chemical energy generated by a reaction of oxygen and hydrogen into electrical energy. As the fuel cell applied to the fuel cell vehicle, a polymer electrolyte membrane (PEM) fuel cell is widely used.

When hydrogen is supplied to a cathode of the PEM fuel cell, the hydrogen is dissociated into hydrogen ions (protons) and electrons on a catalyst layer, and the electrons supply electrical energy to an external load through an external circuit and flow to an anode.

The protons move to the anode through a polymer electrolyte membrane and, when air is supplied to the anode, oxygen combines with the electrons moved from the cathode to become anions on the catalyst layer. The anions combine with the protons transferred through the polymer electrolyte membrane to produce water and, while the protons flow through the polymer electrolyte membrane, a loss due to resistance occurs.

When the polymer electrolyte membrane is sufficiently wetted with water, ion conductivity is increased to reduce the loss due to resistance. Accordingly, when the relative humidity of supplied oxygen and hydrogen is low, the water in the polymer electrolyte membrane is removed, and thus the ion conductivity of the polymer electrolyte membrane is reduced to increase the resistance loss. If the reactant gas having a low relative humidity is continuously supplied, the polymer electrolyte membrane is dried and no longer used as the electrolyte membrane. As such, the humidification of the reactant gas is indispensable to the operation of the PEM fuel cell.

There are various devices for humidifying the PEM fuel cell. For example, a gas-to-gas membrane humidifier is widely used as a conventional device for humidifying the PEM fuel cell.

In the gas-to-gas membrane humidifier, fuel cell exhaust gas flows in one side surface and supply gas flows in the other side surface with an exchange membrane disposed therebetween, through which water permeates. The gas supplied to the membrane humidifier is supplied with heat and water at the same time from the exhaust gas, which is heated and in a water-saturated state as it is discharged from the fuel cell stack.

The gas-to-gas membrane humidifier has advantages in that, since it is supplied with heat and water at the same time, it is possible to reduce the volume of the overall humidifier and to provide a relatively simple structure, compared with other external humidifiers having a separate heat exchanger.

However, the above membrane humidifier has also disadvantages in that the exchange membrane is expensive, and thus the manufacturing cost is high. Moreover, since the reactant gas passes through a narrow and long flow field, a high pressure-drop may occur, and thus the power consumption of a gas supply device is increased. Furthermore, there are problems in that the vehicle may be stopped on an uphill road since the humidification is insufficient in a high load region and the membrane humidifier is hard to control the amount of humidification.

An alternative devise is an injection humidifier. The injection humidification is to increase the humidification efficiency by injecting water to be atomized using an injector in order to increase the surface area for evaporation.

The injection humidification has advantages in that the control of the amount of humidification is facilitated, it is possible to employ an injection humidification technique that has been applied to other fields, and the manufacturing cost is low.

However, the volume of the humidifier is increased to provide sufficient humidification. Moreover, since the injection humidifier is an external humidifier, it has a disadvantage in that it is difficult to apply the same to a vehicle having a limited space.

Accordingly, it is necessary to significantly reduce the volume of the injection humidifier to be applied to a fuel cell vehicle.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art.

In a preferred embodiment, the present invention provides a humidification system using an injector for a fuel cell stack, the humidification system comprising: a fuel cell separator including a reaction flow field, and an air inlet port and an air outlet port formed at a front portion and an end portion of the reaction flow field, respectively; a humidification chamber provided at a part of the front portion of the reaction flow field of the separator; and an injector mounted at a starting point of the humidification chamber to inject a mixture of water and air into the humidification chamber.

In another preferred embodiment, the present invention provides a humidification system using an injector for a fuel cell stack, the humidification system comprising: a fuel cell separator including a reaction flow field, and an air inlet port and an air outlet port formed at a front portion and an end portion of the reaction flow field, respectively; a humidification chamber provided at the whole length of the front portion of the reaction flow field of the separator; and an injector mounted at a starting point of the humidification chamber to inject a mixture of water and air into the humidification chamber.

In the humidification systems of the preferred embodiments, preferably, the injector comprises: an air supply pipe having an orifice shape and arranged horizontally; a water supply pipe connected to the air supply pipe; and a nozzle for injecting to the humidification chamber a mixture of air and water supplied through the air supply pipe and the water supply pipe.

A hydrophilic water absorbent may be coated on an inner surface of the humidification chamber.

The air inlet port of the separator and the air supply pipe of the injector may be connected to each other by a bypass pipe.

A coolant heated after cooling the fuel cell stack may be supplied to the water supply pipe.

Separate humidification water may be heated by a heat exchanger and supplied to the water supply pipe by a pump.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above and other features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a schematic diagram showing a humidification system using an injector for a fuel cell stack in accordance with the present invention;

FIG. 2 is a schematic diagram showing a structure of an injector in accordance with the present invention;

FIG. 3 is a schematic diagram showing a humidification system using an injector for a fuel cell stack in accordance with a preferred embodiment of the present invention;

FIG. 4 is a schematic diagram showing a humidification system using an injector for a fuel cell stack in accordance with another preferred embodiment of the present invention; and

FIG. 5 is a schematic diagram showing a configuration of a fuel cell system to which the humidification system of the present invention is applied.

Reference numerals set forth in the Drawings includes reference to the following elements as further discussed below:

| | |
|---|---|
| 10: air supply pipe | 20: water supply pipe |
| 30: nozzle | 40: air inlet port |
| 50a, 50b: humidification chamber | 52: water absorbent |
| 60: separator | 70: reaction flow field |
| 80: air blower | 90: air outlet port |
| 82: bypass pipe | 84: air compressor |
| 92: water reservoir | 96: circulation pump |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

For a better understanding of the present invention, a structure of a fuel cell stack in a fuel cell vehicle will be briefly described below.

A membrane electrode assembly (MEA), a major component of the fuel cell stack, is disposed at the innermost side of the fuel cell stack and includes a solid polymer electrolyte membrane capable of transferring hydrogen protons and catalyst layers, i.e., an anode and a cathode, formed on both ends of the electrolyte membrane to allow hydrogen and oxygen to react with each other.

Moreover, a gas diffusion layer (GDL) is positioned at the outside of the MEA, i.e., on the surface where the cathode and the anode are positioned, and a separator having flow fields for supplying fuel and exhausting water produced by the reaction is positioned at the outside of the GDL.

In a polymer electrolyte membrane (PEM) fuel cell having the above configuration, since the product water is accumulated in an air outlet port, the electrolyte membrane is in a sufficiently wet state, and thus the humidification is not so much important.

However, air having a temperature lower than the operation temperature of the fuel cell stack is introduced through an air inlet port and, even if the introduced air has a relative humidity of 100%, if the temperature is increased, the relative humidity is rapidly lowered. Accordingly, since the evaporation rate of water is proportional to a difference between the saturated relative humidity of 100% and the relative humidity, the dried state of the electrolyte membrane at the air inlet port is serious.

For such reasons, the humidification of an inlet portion of the fuel cell is the key to the overall humidification of the fuel cell.

A direct internal injection humidification using an injector is effective to humidify the air inlet port and has an effect of cooling the inlet portion of the fuel cell stack by absorption of latent heat required for the evaporation of water as well as the humidification effect.

The direct internal injection humidification is directed to a method capable of reducing the cooling capacity by coolant by reducing the flow amount of coolant of the inlet portion, in the case where the coolant flows in a coolant flow field in the separator to cool heat generated by a reaction so as to maintain the temperature of the fuel cell stack constant. As a result, it is possible to provide effects of reducing the volume of a thermal management system and the cooling capacity.

Compared with the conventional external humidifier that has a certain volume to increase the overall size of the system, the internal injection humidification system can significantly reduce the size of the system since the injector is formed on the separator itself.

According to the present invention, two types of internal injection humidification methods may be employed.

One of the methods is to reduce the size and capacity of the conventional external humidifier, in which the length of a humidification chamber of the separator is relatively short to assist the humidification of the inlet portion, and the other method is to substitute the conventional external humidifier, in which the length of the humidification chamber is relatively long to supply sufficiently humidified air to a reaction flow field.

FIG. 1 is a schematic diagram showing a humidification system, in which an internal injector is applied to an anode side of a fuel cell separator in accordance with the present invention.

FIG. 1 shows an air-assist type injector which is advantageous to the atomization and injection of low pressure air and water. However, other types of injectors may be applicable to the separator for the internal injection humidification.

Reference numeral 60 denotes a separator in the fuel cell stack, and reference numeral 70 denotes a reaction flow field provided in the separator 60 to supply fuel and exhaust water produced by the reaction.

An air inlet port 40 through which air for the reaction is supplied is formed at an inlet of the reaction flow field 70, and an air outlet port 90 through which air is discharged is provided at an outlet of the reaction flow field 70. The injector 100 is placed near the position where the air inlet port 40 of the separator 60 exists.

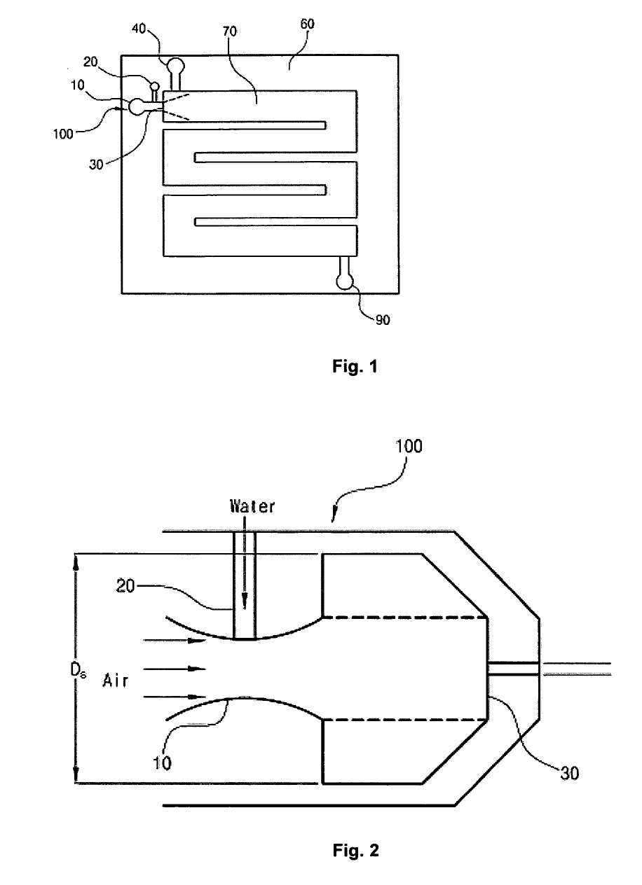

As shown in FIG. 2, the injector 100 includes an air supply pipe 10, a water supply pipe 20, and a nozzle 30. The air supply pipe 10 has an orifice shape and is arranged horizontally. The water supply pipe 20 is arranged in the vertical direction to the air supply pipe 10 and connected thereto. The nozzle 30 atomizes the mixture of air and water supplied from the air supply pipe 10 and the water supply pipe 20, respectively, and injects the atomized mixture. In this case, the velocity of the air supplied through the air supply pipe 10 of the injector 100 is increased at a neck portion of the orifice shape such that the air is pressurized to collide with the water supplied through the water supply pipe 20. Accordingly, the mixture of water and air is injected into the humidification chamber in the separator 60 through the nozzle 30 of the injector 100.

Meanwhile, a portion of the air supplied to the air inlet port 40 may be bypassed to be used as the air supplied to the air supply pipe 10 of the injector 100. For this purpose, the air inlet port 40 of the separator 60 and the air supply pipe 10 of the injector 100 are connected to each other by a bypass pipe.

Preferably, a portion of coolant heated after cooling the fuel cell stack may be used as the water supplied to the water supply pipe 20. In a case where the coolant is an antifreezing solution, such as a mixture of ethylene glycol and water, which may not be directly used for the humidification, a water circuit may be separately provided to supply humidification water heated by a heat exchanger through a pump.

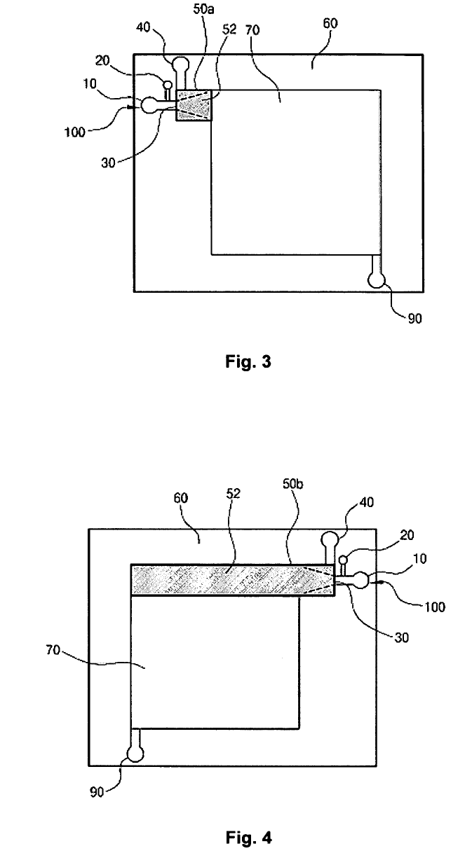

FIG. 3 is a schematic diagram showing a humidification system in accordance with a preferred embodiment of the present invention, in which a humidification-assist type internal injection method is employed.

The humidification-assist type internal injection method is directed to a method for assisting the humidification and reducing the volume and capacity of the conventional external humidifier, and has a characteristic feature in that the length of a humidification chamber 50a is set comparatively short.

As described above, the operation of the injector 100 applied to the separator 60 includes receiving air through the air supply pipe 10 and water through the water supply pipe 20 and injecting the mixture of water and air through the nozzle 30.

The injected water flows through the humidification chamber 50a, i.e., a part of the front portion of the reaction flow field 70 engraved on the separator 60, to humidify the air supplied through the air inlet port 40.

That is, since the humidification chamber 50a is formed with a short length at the starting point of the front portion of the reaction flow field 70, the atomized water is introduced into an air flow field (the reaction flow field starting from the end of the humidification chamber), and the atomized water introduced into the air flow field is evaporated to humidify the air.

At this time, with the evaporation of water, the cooling of the inlet portion of the separator 60 is achieved.

With this humidification-assist injection, it is possible to reduce the volume and capacity of the conventional external humidifier, thus ensuring efficient humidification.

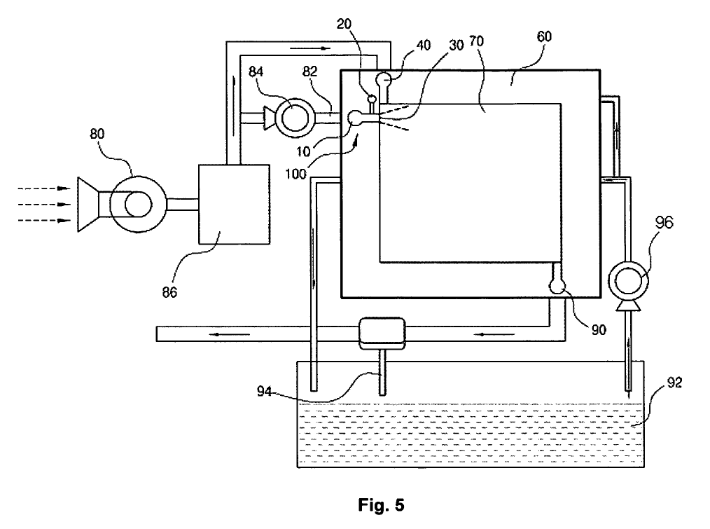

FIG. 4 is a schematic diagram showing a humidification system in accordance with another preferred embodiment of the present invention, in which a humidification-substitution type internal injection method is employed.

In this system, the length of a humidification chamber 50b is set longer than that of the humidification chamber 50a, which enables completely humidified air to be introduced into the reaction flow field 70, i.e., into an air flow field of the reaction region, thereby further improving the humidification efficiency.

In more detail, the humidification chamber 50b is formed to be the same as or longer than the overall length of the front portion of the reaction flow field 70 of the separator 60 such that the mixture of water and air injected through the nozzle 30 of the injector 100 flows through the humidification chamber 50b formed with a long length together with the air supplied through the air inlet port 40 of the separator 60, thus significantly improving the humidification efficiency.

At this time, with the evaporation of the mixture of water and air, the cooling of the inlet portion of the separator 60 is achieved.

With this humidification-substitution injection, the air supplied through the air inlet port 40 flows through the humidification chamber 50b for an increased period of time, and thus the humidification time is increased, thus enabling completely humidified air to be supplied to the inside of the reaction flow field 70.

FIG. 5 is a system diagram showing an internal injection humidification system using an injector in accordance with the present invention.

As shown in FIG. 5, a fuel cell system for a fuel cell vehicle comprises an air supply system for supplying air to the air inlet port 40 of the separator 60 through an air blower 80 for introducing air and a radiator 86 for controlling the air-temperature, and a cooling system including a condenser 94 for condensing the air discharged from the fuel cell stack, a water reservoir 92 for storing the condensed water, and a circulation pump 96 for recirculating the coolant in the water reservoir 92.

Here, since the air supplied through the air blower 80 is introduced into the air inlet port 40 of the separator 60 of the fuel cell stack, a portion of the supply air may be bypassed through an air compressor 84 and a bypass pipe 82 and supplied to the air supply pipe 10 of the injector 100.

The water for cooling the fuel cell stack stored in the water reservoir 92 may be pumped by the circulation pump 96 to be used as the water supplied to the water supply pipe 20 of the injector 100, and a portion of the coolant heated after cooling the fuel cell stack may be used as the water supplied to the water supply pipe 20.

However, in the case where the coolant is an antifreezing solution, such as a mixture of ethylene glycol and water, which may not be directly used for the humidification, a water circuit including a heat exchanger and a pump may be separately provided to supply humidification water heated by the heat exchanger through the pump.

Meanwhile, a hydrophilic water absorbent 52 may be attached or coated on an inner surface of the humidification chamber 50a, 50b in accordance with the present invention to prevent the aqueous water from being directly introduced into the reaction flow field 70 during injection of the mixture of water and air by the injector 100.

As described above, the present invention provides various advantages including the following. Since the mixture of water and air is injected into the reaction flow field of the separator so that the water is atomized to increase the surface area for evaporation, the humidification efficiency increases. By the humidification-assist and/or humidification-substitution injection, it is possible to reduce the volume of the humidification chamber and overall volume of the fuel cell system and/or maximize the humidification efficiency. It is also possible to facilitate system control and reduce manufacturing cost. Further, it is possible to cool the inlet portion of the fuel cell stack by absorption of latent heat according to the evaporation of water as well as the humidification effect.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A humidification system using an injector for a fuel cell stack, the humidification system comprising:
a fuel cell separator including a reaction flow field, and an air inlet port and an air outlet port formed at a front portion and an end portion of the reaction flow field, respectively;
a humidification chamber provided at a part of the front portion of the reaction flow field of the separator; and
an injector mounted at a starting point of the humidification chamber to inject a mixture of water and air into the humidification chamber.

2. The humidification system of claim 1, wherein the injector comprises:
an air supply pipe having an orifice shape and arranged horizontally;
a water supply pipe connected to the air supply pipe; and
a nozzle for injecting to the humidification chamber a mixture of air and water supplied through the air supply pipe and the water supply pipe.

3. The humidification system of claim 1, wherein a hydrophilic water absorbent is coated on an inner surface of the humidification chamber.

4. The humidification system of claim 2, wherein the air inlet port of the separator and the air supply pipe of the injector are connected to each other by a bypass pipe.

5. The humidification system of claim 2, wherein water supplied to the water supply pipe is a coolant heated after cooling the fuel cell stack.

6. The humidification system of claim 1, wherein separate humidification water is heated by a heat exchanger and supplied to the water supply pipe by a pump.

7. A humidification system using an injector for a fuel cell stack, the humidification system comprising:
a fuel cell separator including a reaction flow field, and an air inlet port and an air outlet port formed at a front portion and an end portion of the reaction flow field, respectively;
a humidification chamber provided at the whole length of the front portion of the reaction flow field of the separator; and
an injector mounted at a starting point of the humidification chamber to inject a mixture of water and air into the humidification chamber.

8. The humidification system of claim 7, wherein the injector comprises:
an air supply pipe having an orifice shape and arranged horizontally;
a water supply pipe connected to the air supply pipe; and
a nozzle for injecting to the humidification chamber a mixture of air and water supplied through the air supply pipe and the water supply pipe.

9. The humidification system of claim 7, wherein a hydrophilic water absorbent is coated on an inner surface of the humidification chamber.

10. The humidification system of claim 8, wherein the air inlet port of the separator and the air supply pipe of the injector are connected to each other by a bypass pipe.

11. The humidification system of claim 8, wherein water supplied to the water supply pipe is a coolant heated after cooling the fuel cell stack.

12. The humidification system of claim 7, wherein separate humidification water is heated by a heat exchanger and supplied to the water supply pipe by a pump.
